(19) United States
(12) Patent Application Publication
(10) Pub. No.: US 2022/0148486 A1
(43) Pub. Date: May 12, 2022

(54) INFORMATION PROCESSING APPARATUS AND INFORMATION PROCESSING METHOD AS WELL AS COMPUTER PROGRAM

(71) Applicant: SONY GROUP CORPORATION, TOKYO (JP)

(72) Inventors: KENJI HISANAGA, TOKYO (JP); AKIHIKO IZUMI, TOKYO (JP); TAKUYA NAMAE, TOKYO (JP); HIROSHI MATSUYAMA, TOKYO (JP)

(21) Appl. No.: 17/440,851

(22) PCT Filed: Jan. 27, 2020
(86) PCT No.: PCT/JP2020/002857

§ 371 Date: Sep. 20, 2021

(30) Foreign Application Priority Data
Mar. 29, 2019 (JP) 2019-068140

(51) Int. Cl. G09G 3/20; G09G 3/00; G09G 5/02; G09G 5/377

(52) U.S. Cl. CPC G09G 3/2022; G09G 5/377; G09G 5/02; G09G 3/003

(57) ABSTRACT

An information processing apparatus is provided by which plural scenes are displayed simultaneously with low load.

The information processing apparatus that processes two or more image signals includes a division unit that decomposes the image signals for each color element, a selection unit that selects, from among the color elements of the two or more image signals, a color element of any one of the image signals for each color element, and an outputting unit that outputs the color elements of the image signals for each of predetermined regions. The predetermined regions are plural sub-frames into which one frame is divided in a time direction. The selection unit alternatively selects a color element from among the color elements of the two or more image signals in each of the sub-frames.

### TECHNICAL FIELD

The technology disclosed in the present specification relates to an information processing apparatus and an information processing method as well as a computer program for carrying out a process for displaying plural scenes simultaneously.

### BACKGROUND ART

For example, on an onboard head-up display or the like, it is sometimes desired to overlay plural scenes in display. In particular, it is sometimes desired to display assistance display of a traffic situation as a main scene and simultaneously display a UI (User Interface) as a sub-scene.

As a method of overlaying plural scenes, a method of combining, upon authoring, plural scenes, drawing the combined scene in a VRAM (Video RAM (Random Access Memory)) and outputting the combined scene as display from a display, another method of drawing individual scenes, drawing the scenes once into respective intermediate buffers and then combining the scenes when they are drawn into a VRAM (for example, refer to PTL 1) and so forth are available. However, in the former method, the load when combining processing for scenes is performed upon authoring is heavy, and also in the latter method, it is concerned that the processing load when drawn data of plural intermediate buffers are combined and written into a VRAM is heavy.

### CITATION LIST

### Patent Literature

[PTL 1]

JP 2009-98376A

### SUMMARY

### Technical Problem

An object of the technology disclosed in the present specification resides in provision of an information processing apparatus and an information processing method as well as a computer program by which plural scenes are displayed simultaneously with low load.

### Solution to Problem

The technology disclosed in the present specification has been made taking the subject described above into consideration, and a first aspect of the technology is an information processing apparatus that processes two or more image signals, including:

a division unit that decomposes the image signals for each color element;

a selection unit that selects, from among the color elements of the two or more image signals, a color element of any one of the image signals for each color element; and

an outputting unit that outputs the color elements of the image signals for each of predetermined regions.

The predetermined regions include plural sub-frames into which one frame is divided in a time direction. The selection unit alternatively selects a color element from among the color elements of the two or more image signals in each of the sub-frames.

Alternatively, the predetermined regions include plural sub pixels into which one pixel is divided. The selection unit alternatively selects, for each sub pixel in the pixel, a color element from among the color elements of the two or more image signals.

Meanwhile, a second aspect of the technology disclosed in the present specification is an information processing method for processing two or more image signals, including:

a division step of decomposing the image signals for each color element;

a selection step of selecting, from among the color elements of the two or more image signals, a color element of any one of the image signals for each color element; and

an outputting step of outputting the color elements of the image signals for each of predetermined regions.

Further, a third aspect of the technology disclosed in the present specification is a computer program described in a computer-readable form such that two or more image signals are processed on a computer, the computer program causing the computer to function as:

a division unit that decomposes the image signals for each color element;

a selection unit that selects, from among the color elements of the two or more image signals, a color element of any one of the image signals for each color element; and

an outputting unit that outputs the color elements of the image signals for each of predetermined regions.

The computer program according to the third aspect defines a computer program described in a computer-readable form such that a predetermined process is implemented on the computer. In other words, by installing the computer program according to the third aspect into a computer, cooperative action is exhibited on the computer, and working effects similar to those of the information processing apparatus according to the first aspect can be obtained.

### Advantageous Effect of Invention

According to the technology disclosed in the present specification, an information processing apparatus and an information processing method as well as a computer program can be provided.

It is to be noted that the advantageous effect described in the present specification is exemplary to the last and the advantageous effects brought about by the technology disclosed in the present specification are not restricted to it. Further, the technology disclosed in the present specification sometimes exhibits further advantageous effects in addition to the advantageous effect described above.

Further objects, features, and advantages of the technology disclosed in the present specification will become apparent from the more detailed description based on an embodiment hereinafter described and the accompanying drawings.

### BRIEF DESCRIPTION OF DRAWINGS

FIG. 1 is a view schematically depicting a display driving apparatus 100.

FIG. 2 is a view depicting a procedure when the display driving apparatus 100 displays image signals of plural scenes simultaneously.

FIG. 3 is a view depicting another example of operation of the display driving apparatus 100.

FIG. 4 is a view depicting an example of operation of a display apparatus 120 of the time-division color type when it outputs image signals of a main scene 101 and a sub-scene 102.

FIG. 5 is a view depicting another example of operation of the display apparatus 120 of the time-division color type when image signals of a main scene 101 and a sub-scene 102 are outputted.

FIG. 6 is a view depicting an example of an internal configuration of the display driving apparatus 100.

FIG. 7 is a view depicting a display driving apparatus 700 that displays image signals of plural scenes simultaneously.

### DESCRIPTION OF EMBODIMENT

In the following, an embodiment of the technology disclosed in the present specification is described in detail with reference to the drawings.

There is a problem that, when plural scenes are displayed simultaneously, heavy processing load is applied when the images of the scenes are combined. Therefore, in the present specification, a technology for displaying images of scenes such that the scenes can be observed simultaneously without combining the images of the scenes is proposed in the following.

Although, in the following description, the embodiment to which the technology disclosed in the present specification is applied is described mainly in regard to examples in which two types of scenes including a main scene and a sub-scene are displayed simultaneously for the convenience of simplification in description, the technology disclosed in the present specification can also be applied to a case where three or more types of scenes are displayed simultaneously.

Further, generally an image signal is configured from three color elements of R, G, and B for each pixel. Also in the present specification, for the convenience of description, mainly an embodiment in a case where an image signal composed of RGB color elements is handled is described. However, the technology disclosed in the present specification can similarly be applied to a case where an image signal composed of a color space other than the RGB color space is adopted.

### Working Example 1

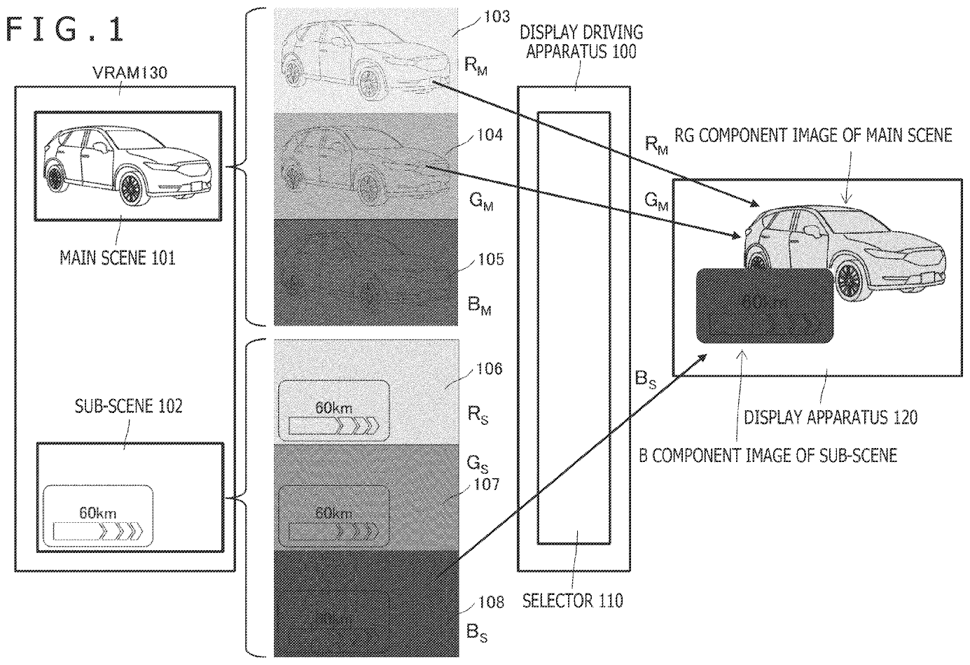

FIG. 1 schematically depicts a display driving apparatus 100 that displays image signals of plural scenes simultaneously by applying the technology disclosed in the present specification. Here, an example is depicted in which an onboard head-up display is used to simultaneously display a main scene denoted by a reference numeral 101 and a sub-scene denoted by a reference numeral 102. The display driving apparatus 100 reads out an image signal expanded on a VRAM 130 and outputs the image signal to a display apparatus 120.

Here, the image signal of the main scene 101 is, for example, for auxiliary display of a traffic situation, and the image signal of the sub-scene 102 is, for example, for a UI. However, it is not specifically restricted which one of the image signals is to be used for the main scene or the sub-scene. The auxiliary display of a traffic situation may be fixed to the main scene and the UI may be fixed to the sub-scene, or otherwise, the image signals to be made the main scene and the sub-scene may be switched according to the degrees of importance of them. Also it is supposed that the degree of importance of each image signal may vary dynamically depending upon the situation (driving situation of the own vehicle or the like).

The main scene 101 and the sub-scene 102 are generated by respective authoring systems and are individually written into the VRAM 130. Although each authoring system may be, for example, a sub-system of a vehicle controlling system, detailed description of this is omitted in the present specification. In addition, the systems for generating respective image signals of the main scene 101 and the sub-scene 102 are not restricted specifically.

The image signal of the main scene 101 is composed of pictures (image signals) 103 to 105 of individual color elements of R, G, and B. If the image signals 103 to 105 of all color elements are read out and outputted simultaneously to the screen of the display apparatus, then one frame of the original main scene 101 is displayed. Similarly, the image signal of the sub-scene 102 is composed of pictures (image signals) 106 to 108 of individual color elements of R, G, and B, and if the image signals 106 to 108 of all color elements are read out and outputted simultaneously to the screen of the display apparatus, then one frame of the original sub-scene 102 is displayed. It is to be noted that “outputted simultaneously” here includes not only a case in which image signals of plural color elements are outputted fully at the same time on the time axis but also a case in which they are outputted time-divisionally within a period of time shorter than the time resolution of the human vision (hereinafter described).

The image signals of the main scene 101 and the sub-scene 102 expanded on the VRAM 130 are individually divided into color elements of R, G, and B. A selector 110 in the display driving apparatus 100 has a function of selecting, for each color element, one of the image signals of the main scene 101 and the sub-scene 102 and outputting the selected image signal to the display apparatus 120. The selector 110 outputs, from within the image signal of the main scene 101, only an image signal or signals of part of the color elements of the image signals 103 to 105 of the color elements of R, G, and B. On the other hand, the selector 110 outputs, from within the image signal of the sub-scene 102, only an image signal or signals of the remaining color element or elements that are not outputted from the main scene 101.

In the example depicted in FIG. 1, during a certain display period, the selector 110 selects image signals R_{M} and G_{M} of R and G from within the image signal of the main scene 101 and selects the remaining image signal B_{S} of B from within the image signal of the sub-scene 102, and outputs the image signals of the color elements simultaneously to the display apparatus 120.

In this case, in a case where the image signals of the main scene 101 and the sub-scene 102 are to be outputted, the selector 110 performs a process of selecting any one of the image signals of the main scene 101 and the sub-scene 102 for each color element during a predetermined display period (1 frame). Along with this, during one display period, the selector 110 does not select all color elements of one of the image signals but selects a color element from within all image signals. As a result, on the screen of the display apparatus 120, an image in which the image signals of the individual color elements of the main scene 101 and the sub-scene 102 are mixed is displayed.

As a result of the color element selection of the image signals by the selector 110, during the relevant display period, R, G, and B composed of the image signals R_{M} and G_{M} of the main scene 101 side and the image signal B_{S} of the sub-scene 102 side are displayed on the screen of the display apparatus 120. Also it can be considered that part of the color elements (in the example depicted, B) of the RGB image signal of the main scene 101 is replaced with the image signal of the sub-scene 102. As a result, an image in which the image signals of the individual color elements of the main scene 101 and the sub-scene 102 are mixed is displayed.

However, only with the image in the display period described above, an image in which part of the color elements are absent in both the main scene 101 and the sub-scene 102 is displayed (the image signal B_{M} of the color element B on the main scene 101 side is absent and the image signals R_{S} and G_{S} of the color elements R and G of the sub-scene 102 are absent). Therefore, during only one display period, an unnatural image is displayed.

Therefore, in the present embodiment, one frame is divided into plural sub-frames, and during each sub-frame, the selector 110 alternatively selects and outputs the image signal of one of the main scene 101 and the sub-scene 102 for each color element. In particular, an image signal of each color element of each scene is outputted from the selector 110 (or from the display driving apparatus 100) to the display apparatus 120 while drawing results for the scenes are not combined.

One frame is, for example, 60 fps (frame per second). One frame is divided into plural sub-frames, and the display apparatus 120 side switches the display image for each sub-frame. One frame is shorter than the time resolution of the human vision. An observer will recognize images of plural consecutive sub-frames within one frame as a combined single image. Accordingly, to the observer, the display images of the sub-frames can be presented as an image of one frame in which the scenes are combined without actually combining drawing results for each scene. Further, upon authoring or upon writing into the VRAM 130, the load in performing the combining process of images of different scenes is reduced.

It is to be noted that, while, in the description of the present working example, an example in which one frame is divided into three sub-frames is described for the convenience of description, even if one frame is divided into four or more frames, naturally the observer can similarly recognize an image of one frame in which images of plural consecutive sub-frames are combined.

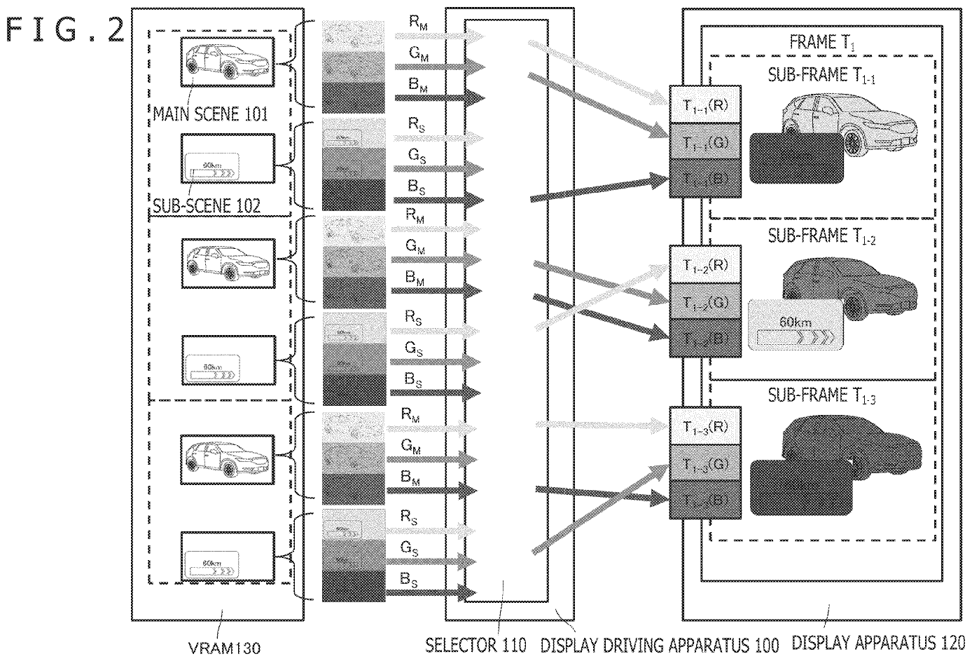

FIG. 2 depicts an example of operation of the display driving apparatus 100 depicted in FIG. 1 for displaying image signals of the main scene 101 and the sub-scene 102 simultaneously by plural consecutive sub-frames. Referring to FIG. 2, a frame T₁ is divided into three consecutive sub-frames T₁₋₁, T₁₋₂, and T₁₋₃.

First, in the sub-frame T₁₋₁, the image signals R_{M} and G_{M} of R and G are selected from within the image signal of the main scene 101 while the image signal B_{S} of remaining B is selected from within the image signal of the sub-scene 102, and the image signals of the color elements are outputted simultaneously to the display apparatus 120. As a result, in the sub-frame T₁₋₁, R, G, and B composed of the image signals R_{M} and G_{M} of the main scene 101 side and the image signal B_{S} of the sub-scene 102 side are displayed on the screen of the display apparatus 120. In short, in the sub-frame T₁₋₁, in place of the color element B from within the RGB image signal of the main scene 101, the image signal of the sub-scene 102 is displayed. As a result, an image in which the image signals of the individual color elements of the main scene 101 and the sub-scene 102 are mixed is displayed.

In the sub-frame T₁₋₂ next to the sub-frame T₁₋₁, the selector 110 selects the image signals G_{M} and B_{M} of G and B from within the image signal of the main scene 101 while it selects the remaining image signal R_{S} of R from within the image signal of the sub-scene 102, and then outputs the image signals of the color elements to the display apparatus 120 simultaneously. As a result, in the sub-frame T₁₋₂, R, G, and B composed of the image signals G_{M} and B_{M} of the main scene 101 side and the image signal R_{S} of the sub-scene 102 side are displayed on the screen of the display apparatus 120. In short, in the sub-frame T₁₋₂, in place of the color element R in the RGB image signal of the main scene 101, the image signal of the sub-scene 102 is displayed. As a result, an image in which the image signals of the individual color elements of the main scene 101 and the sub-scene 102 are mixed is displayed.

As regards the main scene 101, in the frame T₁, the image signal of the color elements of all of R, G, and B is displayed across the two consecutive sub-frames T₁₋₁ and T₁₋₂. Accordingly, the observer can recognize a normal image of the main scene 101 in which the image signals of the two consecutive sub-frames T₁₋₁ and T₁₋₂ are combined and which includes all color elements.

On the other hand, in regard to the sub-scene 102, in the sub-frame T₁₋₁, the image signal only of the color element B is displayed, and in the sub-frame T₁₋₂, an image only of the color element R is displayed. Even if the observer recognizes an image in which the image signals of the two consecutive sub-frames T₁₋₁ and T₁₋₂ are combined, the observer can recognize the sub-scene 102 in which the color element G is still absent.

In the further sub-frame T₁₋₃, the selector 110 selects the image signals B_{M} and R_{M} of the color elements B and R from within the image signal of the main scene 101 while it selects the image signal G_{S} of the remaining color element G from within the image signal of the sub-scene 102, and then outputs the image signals of the color elements to the display apparatus 120 simultaneously. As a result, in the sub-frame T₁₋₃, R, G, and B composed of the image signals B_{M} and R_{M} of the main scene 101 side and the image signal G_{S} of the sub-scene 102 side are displayed on the screen of the display apparatus 120. In short, in the sub-frame T₁₋₃, in place of the color element G from within the RGB image signal of the main scene 101, the mage signal of the sub-scene 102 is displayed. As a result, an image in which the image signals of the individual color elements of the main scene 101 and the sub-scene 102 are mixed is displayed.

Here, if attention is paid to the sub-scene 102, then an image signal of all color elements of R, G, and B are displayed across the three consecutive sub-frames T₁₋₁, T₁₋₂, and T₁₋₃ in the frame T₁. Accordingly, the observer can recognize a normal image of the sub-scene 102 in which the image signals of the three consecutive sub-frames T₁₋₁, T₁₋₂, and T₁₋₃ are combined and which includes all color elements.

In other words, the display driving apparatus 100 makes it possible for the observer to recognize a normal image in which all color elements in the image signals are combined using the number of consecutive sub-frames equal to or greater than the number of image signals to be combined.

Since all color elements are displayed in plural consecutive sub-frames for the individual image signals of the main scene 101 and the sub-scene 102, the observer can combine the consecutive sub-frames in the head and recognize them as a normal image of one frame in which all color elements are complete. In order to achieve such an effect as just described, the selector 110 does not select a color element selected already for any image signal until after outputting of color elements in the image signals of the main scene 101 and the sub-scene 102 is finished in consecutive sub-frames. For example, in regard to the main scene 101, outputting of all color elements is completed in the first two sub-frames T₁₋₁ and T₁₋₂. However, in regard to the sub-scene 102, the color element G is not outputted in the first two sub-frames T₁₋₁ and T₁₋₂ as yet. Therefore, in the third sub-frame T₁₋₃, the selector 110 does not select the image signal of the color element G selected already in the main scene 101 but selects the image signal of the color element G in the sub-scene 102.

The observer (or a human being) will recognize combining all color elements displayed in a period of time shorter than the time resolution of its vision. Accordingly, as described above, in order to allow the observer to recognize images of plural consecutive sub-frames as an image including all color elements of both the main scene 101 and the sub-scene 102, it is necessary to make the period of time required to display all color elements with the image signals of the main scene 101 and the sub-scene 102 shorter than the time resolution of the observer's vision. Accordingly, it is necessary for the selector 110 to select, within the number of sub-frames for which the period of time is shorter than the resolution of the observer's vision, all color elements in the image signals of the main scene 101 and the sub-scene 102.

In the example depicted in FIG. 2, since the number of sub-frames for displaying all color elements in the image signals of the main scene 101 and the sub-scene 102 is three, it is necessary for three consecutive sub-frames to fall within a period of time shorter than the resolution of the observer's vision. For example, if a display of the time-division color type that displays image signals for individual color elements in order such as a single plate type DLP (Digital Light Processing) projector is used as the display apparatus 120, then this allows the observer to recognize a combined image of the main scene 101 and the sub-scene 102 across three consecutive sub-frames.

The requirements for a display of the time-division color type applied to the display apparatus 120 are, for example, such as given below.

(1) That, by high speed driving, image signals of color elements of R, G, and B can be drawn in order each at least once within one frame.

(2) That sub-frames in each of which RGB color elements of each scene are complete each for one time can be displayed by a plural number of times within one frame.

The example of operation depicted in FIG. 2 is the simplest example in which the requirements (1) and (2) described above are satisfied and three sub-frames are drawn per one frame.

Here, the image signals of color elements of R, G, and B of the main scene 101 are represented as R_{M}, G_{M}, and B_{M} using the subscript M. Meanwhile, the image signals of color elements of the R, G, and B of the sub-scene 102 are represented as R_{S}, G_{S}, and B_{S} using the subscript S. Further, the nth frame is represented by Tₙ, and the three sub-frames into which the nth frame is divided are represented as Tₙ₋₁, Tₙ₋₂, and Tₙ₋₃ in order in the time direction. Further, the color elements outputted from the selector 110 in the ith sub-frame when the nth frame is divided (or displayed in the order of the time division on the screen of the display apparatus 120) are represented by Tₙ₋ᵢ(R)ᵣ Tₙ₋ᵢ(G), and Tₙ₋ᵢ(B) (where i is an integer from 1 to 3). In the example of operation depicted in FIG. 2, the color elements outputted from the selector 110 in the sub-frames T₁₋₁, T₁₋₂, and T₁₋₃ of the first frame T₁ are such as follows.

T₁₋₁(R)=R_{M},T₁₋₁(G)=G_{M},T₁₋₁(B)=B_{S}

T₁₋₂(R)=R_{S},T₁₋₂(G)=G_{M},T₁₋₂(B)=B_{M}

T₁₋₃(R)=R_{M},T₁₋₃(G)=G_{S},T₁₋₃(B)=B_{M}

The display driving apparatus 100 mixes and outputs image signals of the color elements of the main scene 101 and the sub-scene 102 for each sub-frame. Further, the selector 110 switches a color element to be selected from each of the main scene 101 and the sub-scene 102 for each sub-frame. It is to be noted, however, that the display driving apparatus 100 merely switches and outputs the image signals of the main scene 101 and the sub-scene 102 for each color element in plural consecutive sub-frames, but does not perform a process for combining drawing results of the main scene 101 and the sub-scene 102.

In a case where the display apparatus 120 of the time-division color type is used, the display driving apparatus 100 consecutively outputs the image signals for the individual color elements in the sub-frames. Along with this, the selector 110 selects one of the main scene 101 and the sub-scene 102 for the individual color elements. In the example depicted in FIG. 2, the display apparatus 120 time-divisionally draws the image signals of the individual color elements in the following order in the frame T₁.

T₁₋₁(R)→T₁₋₁(G)→T₁₋₁(B)→T₁₋₂(R)→T₁₋₂(G)→T₁₋₂(B)→T₁₋₃(R)→T₁₋₃(G)→T₁₋₃(B)

When the displaying order of the image signals of the individual color elements described above is represented by the scene types of the main scene 101 and the sub-scene 102, this becomes such as follows.

R_{M}→G_{M}→B_{S}→R_{S}→G_{M}→B_{M}→R_{M}→G_{S}→B_{M}

Since the display apparatus 120 of the time-division color type time-divisionally draws the image signals for each color element in the order described above, it is possible to present, to the observer, the image signals as an image of one frame in which the scenes are combined without actually combining drawing results for each scene.

Here, the combination ratio of the main scene 101 and the sub-scene 102 in an image of one frame recognized by the observer is examined. In the example of operation depicted in FIG. 2, while the numbers of times of appearance of the color elements R_{M}, G_{M}, and B_{M} of the main scene 101 are twice in one frame, the numbers of times of appearance of the color elements R_{S}, G_{S}, and B_{S} of the sub-scene 102 are once. This is because image signals of two color elements are outputted from the main scene 101 for each sub-frame and an image signal of one color element is outputted from the sub-scene 102. In one frame, image signals of six color elements are outputted from the main scene 101 and image signals of three color elements are outputted from the sub-scene 102. Accordingly, the combination ratio of the main scene 101 and the sub-scene 102 simply is 2:1.

In order to make the combination ratio of the main scene 101 and the sub-scene 102 equal to 1:1, it is sufficient if the numbers of times of appearance of the image signals of the color elements from the scenes for each frame are made coincide with each other. Alternatively, the combination ratio may be made 1:1 by luminance adjustment. For example, in the sub-frames T₁₋₁, T₁₋₂, and T₁₋₃ of the first frame T₁, the luminances of the image signals of the color elements of the main scene 101 are adjusted so as to be made one half as indicated below.

T₁₋₁(R)=R_{M}×½,T₁₋₁(G)=G_{M}×½,T₁₋₁(B)=B_{S}

T₁₋₂(R)=R_{S},T₁₋₂(G)=G_{M}×½,T₁₋₂(B)=B_{M}×½

T₁₋₃(R)=R_{M}×½,T₁₋₃(G)=G_{S},T₁₀₃(B)=B_{M}×½

By using light luminance adjustment that includes only shifting and combining it with allocation of color elements to the scenes for each sub-frame, the combination ratio can be adjusted finely. Further, if the granularity of time division is made finer (that is, if the number of sub-frames configuring one frame is increased), then the combination ratio can be adjusted finely.

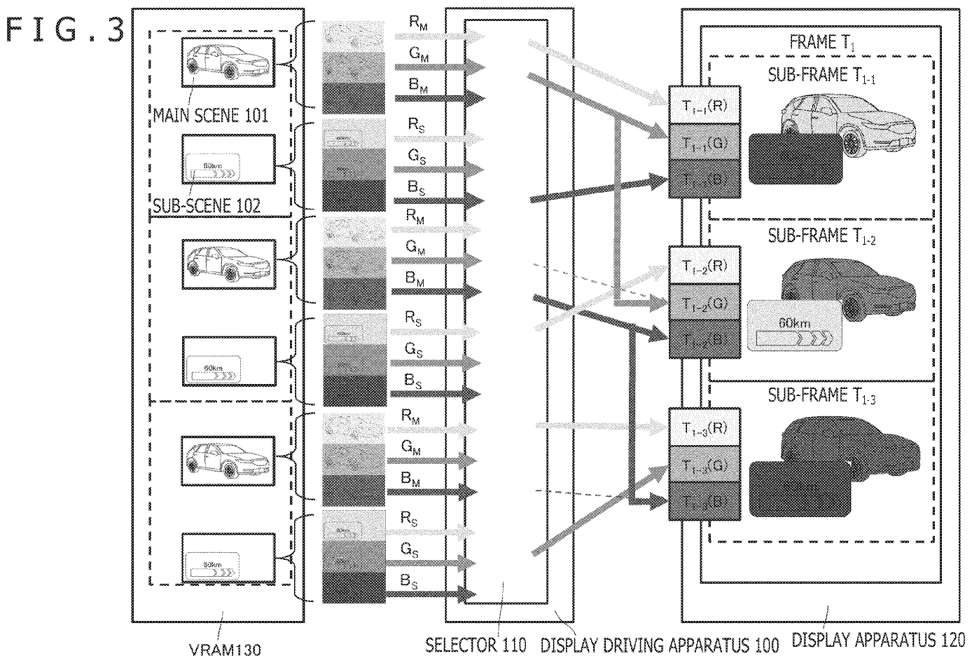

FIG. 3 depicts another example of operation of the display driving apparatus 100 depicted in FIG. 1. Also in the example of operation depicted in FIG. 3, one frame is divided into three sub-frames and image signals of the main scene 101 and the sub-scene 102 are displayed simultaneously in three consecutive sub-frames similarly in FIG. 2. Further, allocation of color elements to the scenes for each sub-frame in one frame in the example of operation depicted in FIG. 3 is performed according to the following combinations similarly in the example of operation depicted in FIG. 2.

T₁₋₁(R)=R_{M},T₁₋₁(G)=G_{M},T₁₋₁(B)=B_{S}

T₁₋₂(R)=R_{S},T₁₋₂(G)=G_{M},T₁₋₂(B)=B_{M}

T₁₋₃(R)=R_{M},T₁₋₃(G)=G_{S},T₁₀₃(B)=B_{M}

According to this example of operation, in both of the consecutive sub-frames T₁₋₁ and T₁₋₂, the image signal (G_{M}) of the color element G of the main scene 101 is selected. In a case where image signals of color elements are common in consecutive sub-frames in such a manner, since the image signal G_{M} already reaches the display apparatus 120 by the first sub-frame T₁₋₁, the image signal G_{M} may not be transmitted by the succeeding sub-frame T₁₋₂. Alternatively, in a case where scenes of color elements are common in consecutive sub-frames, the selector 110 may not select the image signal of the color element in the succeeding sub-frame.

Further, in the example of operation depicted in FIG. 3, also in the consecutive sub-frames T₁₋₂ and T₁₋₃, the image signal (B_{M}) of the color element B of the main scene 101 is selected in common. Accordingly, also in this case, in the succeeding sub-frame T₁₋₃, the image signal B_{M} may not be transmitted. Alternatively, the selector 110 may not select the image signal of the color element B in the succeeding sub-frame T₁₋₃.

### Working Example 2

In the retina of the eye of the human being, photoreceptor cells necessary for the human being to discriminate a shape and a color of an object exist. The photoreceptor cell includes a rod for recognizing light and dark and a cone for recognizing color. The cone includes an L cone for recognizing red (R), an M cone for recognizing green (G), and an S cone for recognizing blue (B). If the observer has all of the L cone, M cone, and S cone as the cones of the photoreceptor cells, then the observer can recognize the three primary colors of R, G, and B individually and can normally see a color represented by the three primary colors.

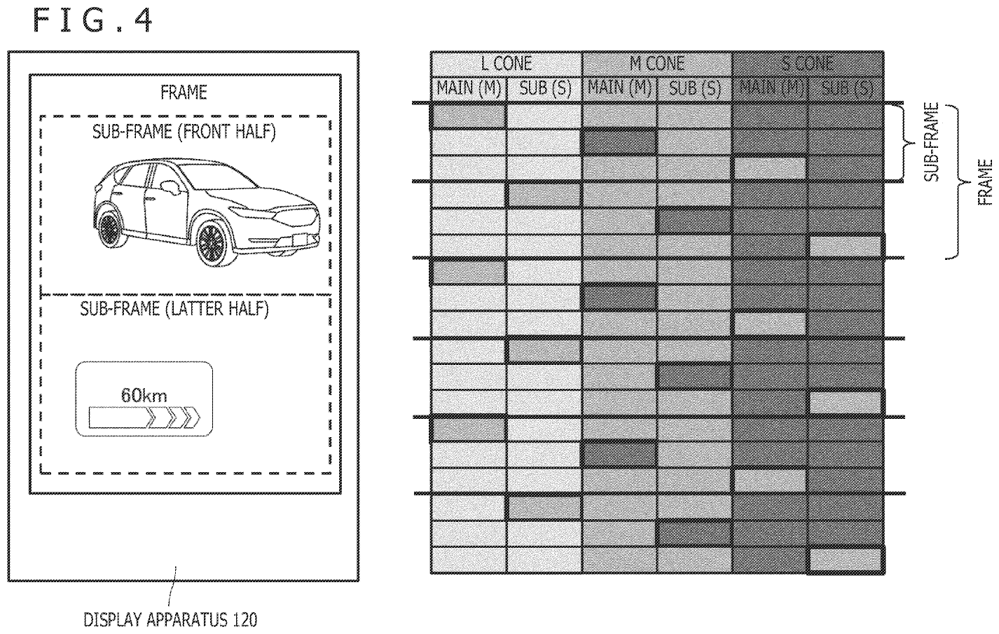

FIG. 4 depicts an example of operation when the display apparatus 120 of the time-division color type outputs image signals of the main scene 101 and the sub-scene 102. However, it is to be noted here that one frame is divided into two sub-frames.

In the example depicted in FIG. 4, the display apparatus 120 operates such that, in the front sub-frame of each frame, an image signal of the main scene 101 that stimulates the L cone, an image signal that stimulates the M cone, and an image signal that stimulates the S cone are displayed in order and, in the latter sub-frame of each frame, an image signal of the sub-scene 102 that stimulates the cone, an image signal that stimulates the M cone, and an image signal that stimulates the S cone are displayed in order.

In the example of operation depicted in FIG. 4, only an RGB image of the main scene 101 and an RGB image of the sub-scene 102 are merely displayed alternately for each sub-frame in one frame, and the observer can merely observe an image in which the RGB image of the main scene 101 and the RGB image of the sub-scene 102 are switched at a high speed. In other words, it is difficult for the observer to recognize that the RGB image of the main scene 101 and the RGB image of the sub-scene 102 are mixed with each other.

Referring to FIG. 4, in each of the main scene 101 and the sub-scene 102, all of an image signal that stimulates the L cone, an image signal that stimulates the M cone, and an image signal that stimulates the S cone are displayed at same time intervals. Therefore, the L cone, M cone, and S cone of the photoreceptor cell of the observer merely receive equivalent stimulations from both the main scene 101 and the sub-scene 102 alternately, and it is difficult for the observer to recognize that the scenes are mixed with each other.

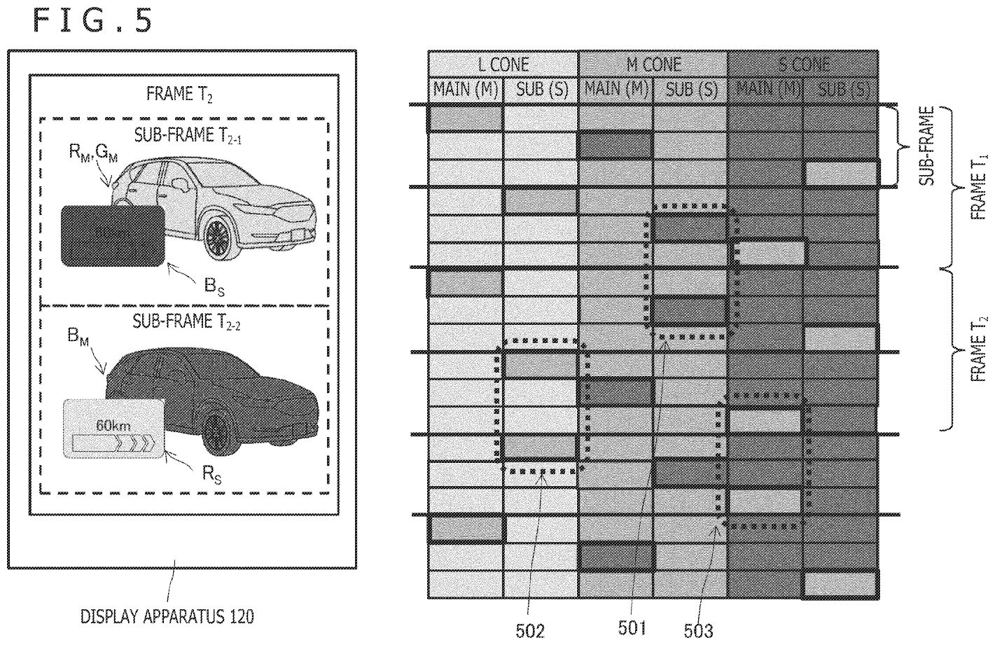

FIG. 5 depicts a further example of operation when the display apparatus 120 of the time-division color type outputs image signals of the main scene 101 and the sub-scene 102. Also here, one frame includes two sub-frames.

The display apparatus 120 operates such that, for each sub-frame of a frame, an image signal that stimulates the L cone, an image signal that stimulates the M cone, and an image signal that stimulates the S cone are displayed time-divisionally. The display apparatus 120 operates such that, in the first frame T₁, during the front sub-frame, an image signal that stimulates the L cone, an image signal that stimulates the M cone, and an image signal that stimulates the S cone of the main scene 101 are displayed in order, and during the latter sub-frame, an image signal that stimulates the L cone, an image signal that stimulates the M cone, and an image signal that stimulates the S cone of the sub-scene 102 are displayed in order.

In the succeeding second frame T₂, replacement of a sub-frame from which an image signal that stimulates the M cone of the main scene 101 and the sub-scene 102 is to be outputted is performed. As a result, the timings at which the sub-scene 102 provides a same stimulation to the M cone of the photoreceptor cell of the observer come nearer to each other as denoted by a reference numeral 501 in FIG. 5, and therefore, the sub-scene 102 can provide a great stimulus to the M cone. As a result, the observer can observe image signals that stimulate the L cone and the S cone of the main scene 101 and an image signal that stimulates the M cone of the sub-scene 102 in a mixed manner in the sub-frame T₂₋₁. It is to be noted that the replacement between image signals of the main scene 101 and the sub-scene 102 is implemented by a selection process of an image signal of the selector 110.

Further, in the third frame T₃, replacement between sub-frames from which image signals of the main scene 101 and the sub-scene 102 that stimulate the L cone and the S cone are to be outputted is performed. As a result, the timings at which the sub-scene 102 provides a same stimulation to the L cone and the S cone of the photoreceptor cell of the observer come nearer to each other, as denoted by reference numerals 502 and 503 in FIG. 5, and therefore, the sub-scene 102 can provide a great stimulus to the L cone and the S cone. As a result, the observer can observe individual image signals that stimulate the L cone and the S cone of the sub-scene 102 and an image signal that stimulates the M cone of the main scene 101 in a mixed manner in the sub-frame T₂₋₁.

By providing roughness to the time interval after which the same image signal stimulates the cones in the time direction (or for each frame) in such a manner, it is possible to allow the observer to recognize an image that is a combination of the main scene 101 and the sub-scene 102.

### Working Example 3

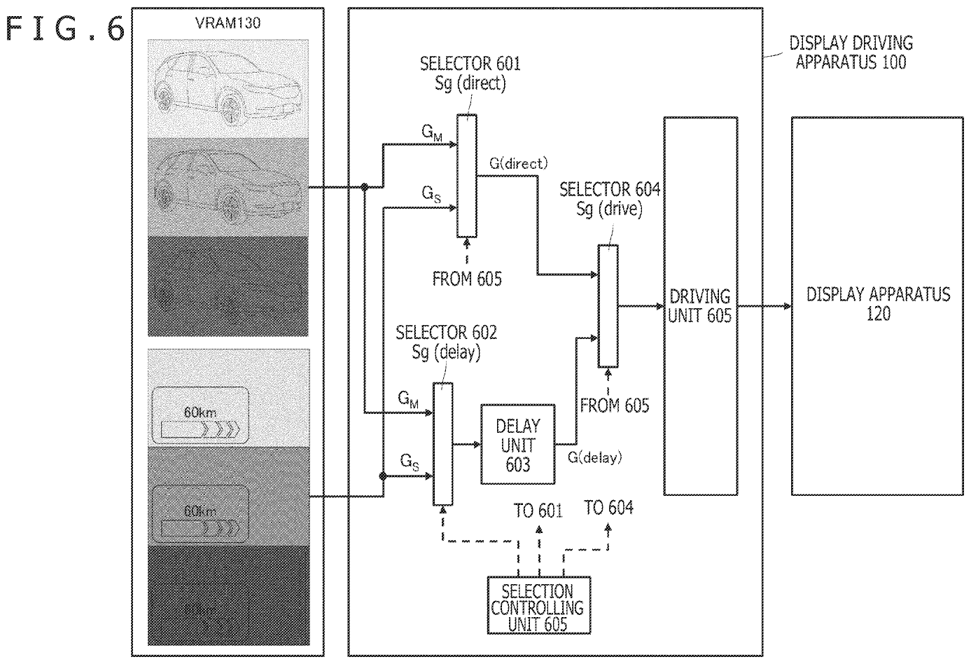

FIG. 6 schematically depicts an example of an internal configuration of the display driving apparatus 100 that causes image signals of the main scene 101 and the sub-scene 102 to be displayed on the display apparatus 120 of the time-division color type.

As described hereinabove, the display driving apparatus 100 selects one of image signals of the main scene 101 and the sub-scene 102 for each color element and outputs the selected image signals simultaneously to the display apparatus 120. Further, in the display driving apparatus 100, all color elements are not selected from an image signal of one of the main scene 100 and the sub-scene 102 in one sub-frame, but at least one color element is selected from both the main scene 101 and the sub-scene 102. As a result, an image in which image signals of the individual color elements of the main scene 101 and the sub-scene 102 are mixed is displayed on the screen of the display apparatus 120.

FIG. 6 schematically depicts an example of an internal configuration of the display driving apparatus 100 specialized for processing principally of an image signal of the color element G. A selector (Sg(direct)) 601 receives, as inputs thereto, both the image signal G_{M} of the color element G of the main scene 101 side and the image signal G_{S} of the color element G of the sub-scene 102 side and alternatively outputs one of the signals as a direct signal G(direct) having no delay. Meanwhile, another selector (Sg(delay)) 602 receives, as inputs thereto, both the image signal G_{M} of the color element G of the main scene 101 side and the image signal G_{S} of the color element G of the sub-scene 102 side and alternatively outputs one of the signals to a delay unit 603.

The delay unit 603 delays the image signal G(direct) of the color element G of one of the scenes inputted from the selector 602 by one sub-frame interval and outputs the delayed signal. A selector (Sg(drive)) 604 selects one of the signal G(direct) read out directly from the VRAM 130 and having no delay and a delayed signal G(delay) outputted from the delay unit 603 and outputs the selected signal as an image signal G(drive) for display driving to a driving unit 605. Then, the display driving signal is outputted from the driving unit 605 to the display apparatus 120.

A selection controlling unit 605 controls selection operation of the selector 601, the selector 602, and the selector 604 for each sub-frame in the frames. In a case where one of the selector 601 and the selector 602 selects the image signal G_{M} of the main scene 101 side, the selection controlling unit 605 causes the selector 601 and the selector 602 to operate such that the other one of the selector 601 and the selector 602 selects the image signal G_{M} of the sub-scene 102 side.

It is to be noted that, although illustration of the configuration for processing image signals of the color elements of R and B is omitted for simplification of the illustration, it is assumed that the display driving apparatus 100 has a configuration similar to that of FIG. 6 for each color element. However, it is assumed that the selection controlling units 605 for the individual color elements operate cooperatively such that, only in one of the scenes, image signals of all color elements are not outputted in a delayed condition. Alternatively, the selectors 601 and 602 and the delay unit 603 may be arranged for each color element such that selection operation of the selectors 601 and 602 of the color elements is controlled totally by the selection controlling unit 605 that is common to all color elements.

Meanwhile, the delay unit 603 may serve also as an image processing circuit for each color element. In this case, delay time arising from an image process is used to provide delay to an output of the image signal. Further, a configuration capable of skipping the delay unit 603 and the image process may be provided. For example, in a case where the image signal of a color element is common between consecutive sub-frames, outputting of the image signal of the color element to the display apparatus 120 can be omitted (refer to the foregoing description and FIG. 3). However, an image process of an image signal in such a sub-frame as just described is unnecessary.

Subsequently, operation of the display driving apparatus 100 is described. It is to be noted that signals of the color elements R, G, and B are denoted by Sᵣ, S_{g}, and S_{b}, respectively. Further, a signal where it is outputted directly from the selector 601 is represented by direct; a signal where it is delayed by and outputted through the delay unit 603 is represented by delay; and a signal that is used for display driving (signal to be inputted to the driving unit 606 of the last stage) is represented by drive.

It is assumed that, in the sub-frame Tₙ₋₁ of the frame Tₙ, color elements are allocated to the main scene 101 and the sub-scene 102 in the following manner.

Tₙ₋₁(R)=R_{M},Tₙ₋₁(G)=G_{S},Tₙ₋₁(B)=B_{S}

At this time, if the display driving apparatus 100 receives an image signal of the main scene 101 (or reads out an image signal of the main scene 101 from the VRAM 130), then the direct signal, the delay signal, and the drive signal of the color elements are such as described below.

Sᵣ(direct)=R_{M},S_{g}(direct)=G_{M},S_{b}(direct)=B_{M}

Sᵣ(delay)=R_{S},S_{g}(delay)=G_{S},S_{b}(delay)=B_{S}

Sᵣ(drive)=R(direct),S_{g}(drive)=G(delay),S_{b}(drive)=B(delay)

It is assumed that, in the following sub-frame Tₙ₋₂ of the frame Tₙ, the color elements are allocated to the main scene 101 and the sub-scene 102 in the following manner.

Tₙ₋₂(R)=R_{S},Tₙ₋₂(G)=G_{M},Tₙ₋₂(B)=B_{S}

At this time, if the display driving apparatus 100 receives an image signal of the sub-scene 102 (or reads out an image signal of the sub-scene 102 from the VRAM 130), then the direct signal, the delay signal, and the drive signal of the color elements are such as described below.

Sᵣ(direct)=R_{S},S_{g}(direct)=G_{S},S_{b}(direct)=B_{S}

Sᵣ(delay)=R_{M},S_{g}(delay)=G_{M},S_{b}(delay)=B_{M}

Sᵣ(drive)=R(direct),S_{g}(drive)=G(delay),S_{b}(drive)=B(direct)

### Working Example 4

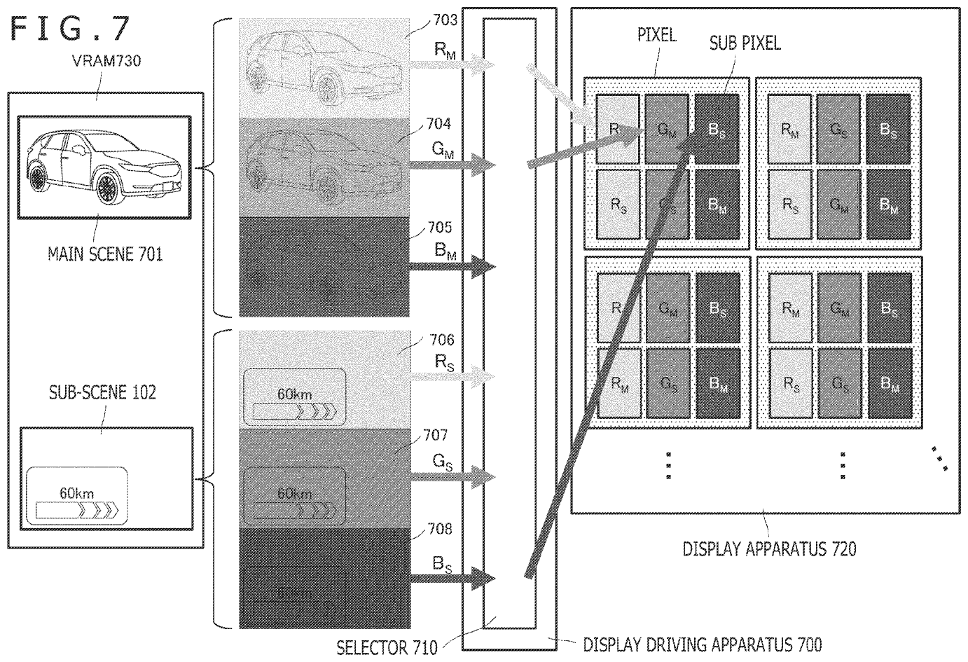

FIG. 7 schematically depicts a display driving apparatus 700 that displays image signals of plural scenes simultaneously. Here, it is assumed that the display driving apparatus 700 outputs an image signal to a display apparatus 720 in which each pixel is composed of plural sub pixels. In FIG. 7, it is assumed that one pixel is configured from three sub pixels each including two sub pixels of color elements of R, G, and B.

The display driving apparatus 700 reads out image signals of a main scene 701 and a sub-scene 702 expanded on a VRAM 730 and outputs the image signals to the display apparatus 720. Here, the main scene 701 and the sub-scene 702 are similar to those described in the foregoing description of the working example 1, and detailed description of them is omitted here. The image signal of the main scene 701 is composed of pictures (image signals) 703 to 705 of the individual color elements of R, G, and B. Similarly, the image signal of the sub-scene 702 is composed of pictures (image signals) 706 to 708 of the individual color elements of R, G, and B.

Each of the image signals of the main scene 701 and the sub-scene 702 expanded on the VRAM 730 is divided into color elements of R, G, and B. A selector 710 in the display driving apparatus 700 has a function of selecting, for each sub pixel of the pixels, one of the image signals of the main scene 701 and the sub-scene 702 and outputting the selected image signal to the display apparatus 720. The selector 710 outputs, in the pixels, from the image signal of the main scene 701, only an image signal of the color element or elements of part of the image signals 703 to 705 of the color elements of R, G, and B and outputs, from the image signal of the sub-scene 702, only the image signal of the remaining color element or elements, which is not outputted from the main scene 701.

In the example depicted in FIG. 7, the selector 710 selects, for the sub pixels for the color elements R and G among the three sub pixels in the pixel at the upper left end of the figure, the image signals R_{M} and G_{M} of the main scene 701 and selects, for the sub pixel for the color element B, the image signal B_{S} of the sub-scene 702, and outputs the selected image signals simultaneously to the display apparatus 720. Although detailed description about the other pixels is omitted, all color elements of the scenes can be represented using the number of pixels equal to or greater than the total number of the color elements of the main scene 701 and the sub-scene 702, namely, equal to or greater than 6 pixels. In a case where the image signals of the main scene 701 and the sub-scene 702 are outputted, the selector 710 performs a process of selecting any one of the image signals of the main scene 701 and the sub-scene 702 for each sub pixel in the pixels. Along with this, the selector 710 does not select only one of the image signals in all sub pixels in one pixel and selects all image signals for one of the sub pixels.

Allocation of the image signals of the main scene 701 and the sub-scene 702 to sub pixels differs in respective pixels. In other words, the allocation of sub pixels changes depending upon the spatial direction. Naturally, for a same pixel, allocation of a sub pixel may be changed in the time direction (or for each frame). In any case, allocation of sub pixels can be changed in the spatial direction and the time direction by selection operation of an image signal by the selector 710. Further, the combination ratio of scenes depends upon the ratio in total number of sub pixels allocated to the scenes. The allocation of sub pixels may be finely adjusted in response to the combination ratio of scenes. The allocation of sub pixels can be finely adjusted in response to the height of the resolution of the display apparatus 720 with respect to the resolution of the visual system of the human being. As the resolution of the display apparatus 720 becomes higher, a finer scene combination ratio can be implemented.

Since image signals of color elements of the main scene 701 and image signals of color elements of the sub-scene 702 are deployed in such a manner as described above for each pixel, the observer will observe an image in which the image signals are mixed. Further, in a case where the display apparatus 720 has such a resolution as sufficiently exceeds the vision resolution of the observer (or the human being), the observer can recognize the image as a combined image of the main scene 701 and the sub-scene 702.

Also in the present working example, a drawing result for each scene can be presented, to the observer, as an image of one frame in which the scenes are combined without actually combining drawing results for each scene. Further, the load when images of scenes are subjected to a combining process upon authoring or upon writing into the VRAM 130 is reduced. It is to be noted that the configuration of a pixel depicted in FIG. 7 (or the array of sub pixels of color elements in a pixel) is nothing but an example, and even with some other array of color elements, a combining process of images of plural scenes can be implemented by a similar method.

### Working Example 5

In the working examples, it is supposed that the main scene is display relating to the real world such as assistance to a traffic situation while the sub-scene is UI display and that the main scene is information having a higher degree of importance. On the other hand, it is supposed that the UI is displayed on the foreground. Therefore, specifically important information in the main scene is preferably displayed emphatically such that it is not hidden behind the sub-scene.

Further, even where the main scene is not hidden behind the sub-scene, in a case where the main scene includes scenery in the dark such as at night or in a tunnel, the visibility of the observer drops, and therefore, it is desirable that the scenery in the dark is displayed emphatically such that it is not hidden behind the sub-scene.

It can be considered that, in the main scene, a red component is specifically important such as a warning color of a tail lamp or the like or a red signal that must not be overlooked in a traffic signal. Accordingly, it is necessary to emphatically display a red component in the main scene such that it is not overlaid by the sub-scene.

Since the recognition ratio of red clothes drops at night (although the rod cell operates together with the cone cell and operates even with weak light, it cannot distinguish the color of it), it is desirable that a red component is emphatically displayed in response to the brightness.

Further, since the cone cell has a property that, although it is high in sensitivity to front incidence, it is low in sensitivity to peripheral incidence (Stiles-Crawford effect), it is desirable to emphatically display a red component positioned in a peripheral vision.

There is a problem also that the sensitivity to each color element differs among different observers. For example, since an aged person is degraded in sensitivity to blue, it is necessary to emphatically display also a blue component. At night, it is desirable to emphatically display a component within a range of blue to green.

Further, in a case where the observer has color vision deficiency, a region in which a color that is difficult to distinguish exists in the main scene is detected and is emphatically displayed by fluctuating the luminance or the saturation of the color in the region or like means.

Emphatic display of the main scene can be carried out, for example, by the following procedure.

Step 1) A region to be emphatically displayed is detected.

Basically, a region of a red component in the main scene is detected. However, a region of a color element other than a red component is detected depending upon an attribute or a feature of the observer such as an aged person or color vision deficiency.

Step 2) The necessity for emphatic display is decided.

Emphatic display may always be carried out for the region detected in step 1. However, since the emphatic display changes and makes the real world view unnatural, execution of emphatic display may be controlled according to the necessity. For example, in a case where the relevant region is overlaid by the sub-scene, when an event in regard to which it is difficult for the observer to recognize the region such as when the visibility (of a red component) drops because of a dark place such as at night or when the region is a peripheral vision or in a like case, it is decided that emphatic display is necessary.

Step 3) Emphatic display is executed.

The luminance of the relevant region such as a red component is increased for emphasis. The color element to be emphasized is added or changed in response to an attribute or a feature of the observer such as an aged person or color vision deficiency. Further, in a case where the relevant region is overlaid by the sub-scene, the region is overlaid on the sub-scene such that it is not hidden. In a case where the observer has color vision deficiency, since mere increase of the luminance does not improve the visibility, the luminance or the saturation is fluctuated to make the region visually appealing.

### INDUSTRIAL APPLICABILITY

The technology disclosed in the present specification has been described in detail with reference to the specific embodiment. However, it is apparent that a person skilled in the art could make amendment or substitution of the embodiment without departing from the subject matter of the technology disclosed in the present specification.

Although, in the present specification, description has been given mainly of an embodiment in which two kinds of scenes including a main scene and a sub-scene are displayed simultaneously, the technology disclosed in the present specification can also be applied to a case where three or more kinds of scenes are displayed simultaneously. Further, although, in the present specification, description is given mainly of an embodiment in a case in which an image signal composed of color elements of R, G, and B is handled, the technology disclosed in the present specification can similarly be applied to a case where an image signal composed of a color space other than the RGB color space is adopted.

Although the technology disclosed in the present specification can be incorporated in and utilized together with a mobile apparatus such as, for example, an automobile, the technology can naturally be applied to information processing apparatus of various types in which an image is displayed on a display.

In short, although the technology disclosed in the present specification has been described in the form of exemplification, the contents of the description of the present specification shall not be interpreted restrictively. In order to determine the subject matter of the technology disclosed in the present specification, the claims should be referred.

It is to be noted that it is also possible for the technology disclosed in the present specification to take such configurations as described below.

(1)

An information processing apparatus that processes two or more image signals, including:

a division unit that decomposes the image signals for each color element;

a selection unit that selects, from among the color elements of the two or more image signals, a color element of any one of the image signals for each color element; and

an outputting unit that outputs the color elements of the image signals for each of predetermined regions.

(2)

The information processing apparatus according to (1) above, in which

the predetermined regions include plural sub-frames into which one frame is divided in a time direction.

(3)

The information processing apparatus according to (2) above, in which

the selection unit alternatively selects a color element from among the color elements of the two or more image signals in each of the sub-frames.

(4)

The information processing apparatus according to (2) or (3) above, in which

the selection unit selects at least one color element from each of the two or more image signals in one sub-frame.

(5)

The information processing apparatus according to any one of (2) to (4) above, in which

the number of sub-frames included in the one sub-frame is equal to or greater than the number of image signals.

(6)

The information processing apparatus according to any one of (2) to (5) above, in which

the selection unit selects, in the sub-frames included in the one frame, the color elements of the two or more image signals at least once.

(7)

The information processing apparatus according to any one of (2) to (6) above, in which

the selection unit selects, in plural sub-frames displayed within a period of time shorter than a time resolution of vision of an observer, all color elements in each of the two or more image signals.

(8)

The information processing apparatus according to any one of (2) to (7) above, in which,

in a case where an image signal of a color element selected in consecutive sub-frames is common, the image signal is not outputted newly in the succeeding sub-frame.

(8-1)

The information processing apparatus according to (8) above, in which,

in a case where an image signal of a color element is common in consecutive sub-frames, the selection unit does not newly select the image signal of the sub-frame in the succeeding sub-frame.

(9)

The information processing apparatus according to any one of (2) to (8) above, in which

the image signals of the individual color elements selected in the sub-frames are outputted in order to a display apparatus of a time-division color type.

(10)

The information processing apparatus according to (2) above, in which

the selection unit selects the same color element of one image signal in sub-frames that are close to each other in time.

(11)

The information processing apparatus according to (1) above, in which

the predetermined regions include plural sub pixels into which one pixel is divided.

(12)

The information processing apparatus according to (12) above, in which

the selection unit alternatively selects, for each sub pixel in the pixel, a color element from among the color elements of the two or more image signals.

(13)

The information processing apparatus according to (11) or (12) above, in which

the selection unit selects, in one pixel, at least one color element from each of the two or more image signals.

(14)

The information processing apparatus according to any one of (11) to (13) above, in which

the number of sub pixels included in a pixel is equal to or greater than a total of the color elements of the two or more image signals.

(15)

The information processing apparatus according to any one of (1) to (14) above, in which

some of the color elements of the image signals are controlled so as to be emphatically displayed.

(16)

The information processing apparatus according to (15) above, in which

some of the color elements of the image signals are controlled so as to be emphatically displayed according to vision of an observer.

(17)

The information processing apparatus according to any one of (1) to (16) above, in which

the two or more image signals include a main scene and a sub-scene.

(17-1)

The information processing apparatus according to (18) above, in which

the two or more image signals are allocated to the main scene and the sub-scene according to a degree of importance.

(18)

An information processing method for processing two or more image signals, including:

a division step of decomposing the image signals for each color element;

a selection step of selecting, from among the color elements of the two or more image signals, a color element of any one of the image signals for each color element; and

an outputting step of outputting the color elements of the image signals for each of predetermined regions.

(19)

A computer program described in a computer-readable form such that two or more image signals are processed on a computer, the computer program causing the computer to function as:

a division unit that decomposes the image signals for each color element;

a selection unit that selects, from among the color elements of the two or more image signals, a color element of any one of the image signals for each color element; and

an outputting unit that outputs the color elements of the image signals for each of predetermined regions.

### REFERENCE SIGNS LIST

100: Display driving apparatus
110: Selector
120: Display apparatus
130: VRAM
601: Selector (Sg(direct))
602: Selector (Sg(delay))
603: Delay unit
604: Selector (Sg(drive))
605: Selection controlling unit
606: Driving unit
700: Display driving apparatus
710: Selector
720: Display apparatus
730: VRAM

1. An information processing apparatus that processes two or more image signals, comprising:
a division unit that decomposes the image signals for each color element;
a selection unit that selects, from among the color elements of the two or more image signals, a color element of any one of the image signals for each color element; and
an outputting unit that outputs the color elements of the image signals for each of predetermined regions.

2. The information processing apparatus according to claim 1, wherein
the predetermined regions include plural sub-frames into which one frame is divided in a time direction.

3. The information processing apparatus according to claim 2, wherein
the selection unit alternatively selects a color element from among the color elements of the two or more image signals in each of the sub-frames.

4. The information processing apparatus according to claim 2, wherein
the selection unit selects at least one color element from each of the two or more image signals in one sub-frame.

5. The information processing apparatus according to claim 2, wherein
the number of sub-frames included in the one sub-frame is equal to or greater than the number of image signals.

6. The information processing apparatus according to claim 2, wherein
the selection unit selects, in the sub-frames included in the one frame, the color elements of the two or more image signals at least once.

7. The information processing apparatus according to claim 2, wherein
the selection unit selects, in plural sub-frames displayed within a period of time shorter than a time resolution of vision of an observer, all color elements in each of the two or more image signals.

8. The information processing apparatus according to claim 2, wherein,
in a case where an image signal of a color element selected in consecutive sub-frames is common, the image signal is not outputted newly in the succeeding sub-frame.

9. The information processing apparatus according to claim 2, wherein
image signals of the individual color elements selected in the sub-frames are outputted in order to a display apparatus of a time-division color type.

10. The information processing apparatus according to claim 2, wherein
the selection unit selects a same color element of one image signal in sub-frames that are close to each other in time.

11. The information processing apparatus according to claim 1, wherein
the predetermined regions include plural sub pixels into which one pixel is divided.

12. The information processing apparatus according to claim 11, wherein
the selection unit alternatively selects, for each sub pixel in the pixel, a color element from among the color elements of the two or more image signals.

13. The information processing apparatus according to claim 11, wherein
the selection unit selects, in one pixel, at least one color element from each of the two or more image signals.

14. The information processing apparatus according to claim 11, wherein
the number of sub pixels included in a pixel is equal to or greater than a total of the color elements of the two or more image signals.

15. The information processing apparatus according to claim 1, wherein
some of the color elements of the image signals are controlled so as to be emphatically displayed.

16. The information processing apparatus according to claim 15, wherein
some of the color elements of the image signals are controlled so as to be emphatically displayed according to vision of an observer.

17. The information processing apparatus according to claim 1, wherein
the two or more image signals include a main scene and a sub-scene.

18. An information processing method for processing two or more image signals, comprising:
a division step of decomposing the image signals for each color element;
a selection step of selecting, from among the color elements of the two or more image signals, a color element of any one of the image signals for each color element; and
an outputting step of outputting the color elements of the image signals for each of predetermined regions.

19. A computer program described in a computer-readable form such that two or more image signals are processed on a computer, the computer program causing the computer to function as:
a division unit that decomposes the image signals for each color element;
a selection unit that selects, from among the color elements of the two or more image signals, a color element of any one of the image signals for each color element; and
an outputting unit that outputs the color elements of the image signals for each of predetermined regions.
